(19) United States
(12) Patent Application Publication
(10) Pub. No.: US 2026/0253334 A1
(43) Pub. Date: Aug. 27, 2026

(54) METHODS AND DEVICES FOR VIEWPOINT SELECTION IN MESH QUALITY ANALYSIS

(71) Applicant: Tencent America LLC, Palo Alto, CA (US)

(72) Inventors: Fang-Yi CHAO, Palo Alto, CA (US); Pranav KADAM, Palo Alto, CA (US); Shan LIU, Palo Alto, CA (US)

(21) Appl. No.: 19/443,998

(22) Filed: Jan. 8, 2026

Related U.S. Application Data
(60) Provisional application No. 63/763,221, filed on Feb. 25, 2025.

(51) Int. Cl. G06T 17/20; G06T 15/20

(52) U.S. Cl. CPC G06T 17/20; G06T 15/20

(57) ABSTRACT

An example method of mesh assessment includes obtaining a three-dimensional (3D) source mesh and obtaining a 3D reconstructed mesh corresponding to the 3D source mesh. The method also includes selecting a set of viewpoints for evaluating the 3D reconstructed mesh, where at least a subset of the set of viewpoints are not predefined. The method further includes generating a set of quality metrics for the 3D reconstructed mesh by determining, for each viewpoint in the set of viewpoints, a corresponding quality metric for the 3D reconstructed mesh. The method also includes evaluating the 3D reconstructed mesh using a combined quality metric for the 3D reconstructed mesh based on set of quality metrics.

### RELATED APPLICATIONS

This application claims priority to U.S. Provisional Patent Application No. 63/763,221, entitled “Method and Apparatus for Viewpoints Selection in Mesh Quality Metric,” filed Feb. 25, 2025, which is hereby incorporated by reference in its entirety.

### TECHNICAL FIELD

The present disclosure relates to three-dimensional mesh quality assessment, including but not limited to methods and devices for selecting viewpoints in projection-based mesh quality assessments.

### BACKGROUND

Three-dimensional mesh representations are used in computer graphics, virtual reality, augmented reality, and various multimedia applications. These mesh representations describe objects and scenes using vertices, edges, and faces that form geometric surfaces. As mesh coding standards continue to develop, there is an increasing focus on ways to assess the quality of mesh data, particularly after compression, transmission, or other processing operations that may introduce distortions.

Standardization efforts for mesh coding have emerged to address the growing demand for efficient representation and transmission of three-dimensional content. The Alliance for Open Media (AOM) has been developing the Volumetric Visual Media (VVM) standard, which focuses on compression and delivery of volumetric video content including dynamic meshes. Similarly, the Moving Picture Experts Group (MPEG) has been working on the Video-based Dynamic Mesh Coding (V-DMC) standard, also referred to as VMesh, which targets efficient coding of time-varying mesh sequences. These standards aim to enable practical deployment of volumetric video services across various applications such as telepresence, immersive entertainment, and virtual collaboration.

### SUMMARY

There is a need for objective quality metrics that can reliably assess the fidelity of reconstructed meshes relative to their source counterparts. Projection-based mesh quality metrics correlate with subjective quality assessments by rendering meshes from multiple viewpoints and applying established two-dimensional image quality metrics to the rendered views. However, the selection of viewpoints for such projection-based assessments presents challenges, as predefined viewpoint configurations may introduce biases or fail to capture quality variations across different regions of a mesh. For example, fixed or predetermined viewpoint configurations may be susceptible to optimization by mesh codecs that are aware of the specific viewpoints being used for evaluation. Additionally, viewpoint selection strategies that rely on a single axis of rotation may not adequately capture quality variations across all regions of a mesh. Different mesh types, such as interior room scenes versus exterior object scans, may benefit from different viewpoint positioning strategies.

The present disclosure describes, amongst other things, methods and systems for selecting viewpoints for mesh quality metrics. To prevent mesh codecs from gaming the evaluation process, some embodiments randomly select the number of viewpoints or their angular positions using a random number generator. Viewpoints may be distributed at uniform angular intervals, assigned random positions along a rotation axis, or placed using a combination where a first viewpoint is randomly chosen and the rest are uniformly spaced from that starting point. Some embodiments enforce minimum separation between viewpoints through a randomly selected angular threshold, while others define exclusion ranges to skip less relevant areas like blank surfaces. Rather than limiting viewpoints to a single horizontal axis, some embodiments select viewpoints along multiple randomly determined rotation axes or use a spherical coordinate system for comprehensive coverage. Viewing distances can also be varied to zoom in on intricate features or zoom out for broader views. Additionally, Fibonacci sphere sampling may be used to achieve uniform distribution across the viewing sphere. These approaches help ensure more accurate distortion measurement and prevent codecs from being optimized for specific predetermined viewpoints.

In accordance with some embodiments, a method of selecting viewpoints includes: (i) obtaining a three-dimensional (3D) source mesh; (ii) obtaining a 3D reconstructed mesh corresponding to the 3D source mesh; (iii) selecting a set of viewpoints for evaluating the 3D reconstructed mesh, where at least a subset of the set of viewpoints are not predefined; (iv) generating a set of quality metrics for the 3D reconstructed mesh by determining, for each viewpoint in the set of viewpoints, a corresponding quality metric for the 3D reconstructed mesh; and (v) evaluating the 3D reconstructed mesh using a combined quality metric for the 3D reconstructed mesh based on set of quality metrics.

In accordance with some embodiments, a computing system is provided, such as a mesh processing system, a volumetric video streaming server, a mesh quality evaluation system, or other electronic device configured for three-dimensional mesh coding and analysis. The computing system includes control circuitry and memory storing one or more sets of instructions. The one or more sets of instructions including instructions for performing any of the methods described herein, including viewpoint selection for projection-based mesh quality metrics. In some embodiments, the computing system includes a mesh encoder component and a mesh decoder component configured to process mesh data according to mesh coding standards such as V-DMC or VVM standards.

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein, including selecting viewpoints for evaluating three-dimensional mesh quality, rendering meshes from selected viewpoints, and computing quality metrics based on the rendered views.

Thus, devices and systems are disclosed with methods for encoding, decoding, and assessing three-dimensional mesh data. Such methods, devices, and systems may complement or replace conventional methods, devices, and systems for mesh coding and mesh quality assessment, including projection-based mesh quality metrics that evaluate reconstructed meshes by rendering viewpoints and applying image quality metrics to the rendered views.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2 is a block diagram illustrating an example computing system in accordance with some embodiments.

FIG. 3 is a block diagram illustrating an example projection-based mesh quality assessment in accordance with some embodiments.

FIGS. 4A-4F illustrate example viewpoint selections in accordance with some embodiments.

FIG. 5 is a flowchart illustrating a method of selecting viewpoints for evaluating a three-dimensional mesh in accordance with some embodiments.

In accordance with common practice, the various features illustrated in the drawings are not necessarily drawn to scale, and like reference numerals can be used to denote like features throughout the specification and figures.

### DETAILED DESCRIPTION

Mesh coding encompasses techniques for compressing and transmitting three-dimensional mesh data, which may include geometric information such as vertex positions and connectivity, as well as associated texture and attribute data. Projection-based mesh quality metrics (pbMQM) provide an approach for evaluating the quality of reconstructed meshes by rendering the mesh from multiple viewpoints and applying two-dimensional image quality metrics, such as Video Multimethod Assessment Fusion (VMAF), to the rendered views. The quality scores from individual viewpoints may be aggregated to produce a combined quality metric that correlates with subjective quality assessments. However, conventional pbMQM implementations use predefined viewpoints, which can introduce biases and may allow mesh codecs to optimize specifically for those known viewpoint positions.

The present disclosure addresses these limitations through various viewpoint selection techniques. In some aspects, the number of viewpoints may be randomly selected, and viewpoints may be assigned uniform angular spacing or random angular positions along a rotation axis. In some cases, a first viewpoint may be randomly selected, with remaining viewpoints uniformly distributed from that starting position, which can help avoid clustering of randomly selected viewpoints while still preventing codecs from targeting specific angles. Some embodiments enforce minimum angular separation between viewpoints (e.g., through a randomly selected threshold), and exclusion ranges may be defined to omit less relevant viewing angles such as those facing uniform or blank surfaces. Rather than limiting viewpoints to a single horizontal axis, some embodiments select viewpoints along multiple randomly determined rotation axes or employ a spherical coordinate system with longitude and latitude parameters for more comprehensive coverage. Viewing distances may also be varied to enable closer inspection of intricate features or broader views of the overall mesh. Additionally, Fibonacci sphere sampling may be used to achieve uniform distribution of viewpoints across the viewing sphere. These approaches may provide more accurate distortion measurement and may help prevent mesh codecs from being optimized for specific predetermined viewpoints.

### Example Systems and Devices

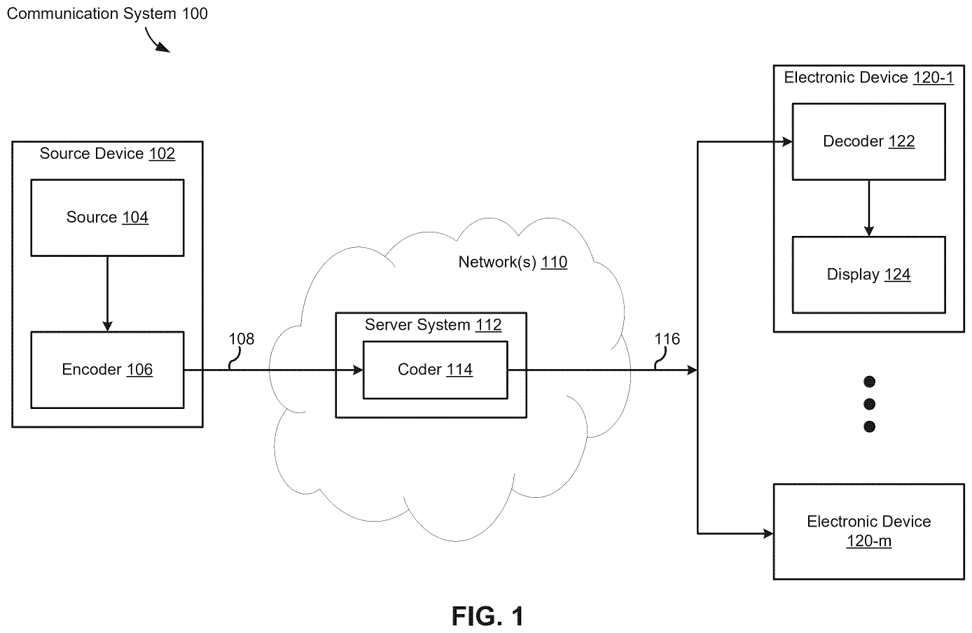

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with volumetric media applications such as three-dimensional mesh streaming applications, immersive video conferencing applications, and volumetric media storage and/or distribution applications.

The source device 102 includes a source 104 (e.g., a depth camera array, RGB-D camera system, or media storage) and an encoder component 106. In some embodiments, the source 104 is a set of calibrated cameras configured to capture three-dimensional mesh data representing objects or scenes. The encoder component 106 generates one or more encoded bitstreams from the captured mesh data. The mesh data from the source 104 may be high data volume as compared to the encoded bitstream 108 generated by the encoder component 106. Because the encoded bitstream 108 is lower data volume (less data) as compared to the mesh data from the source, the encoded bitstream 108 requires less bandwidth to transmit and less storage space to store as compared to the mesh data from the source 104. In some embodiments, the source device 102 does not include the encoder component 106 (e.g., is configured to transmit uncompressed mesh data to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute volumetric content such as the encoded mesh data from the source device 102). The server system 112 includes a coder component 114 (e.g., configured to encode and/or decode mesh data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded bitstream 108 and re-encode the mesh data using a different encoding standard and/or methodology to generate encoded data 116. In some embodiments, the server system 112 is configured to generate multiple formats and/or encodings from the encoded bitstream 108, such as different mesh resolutions or quality levels. In some embodiments, the server system 112 functions as a Media-Aware Network Element (MANE). For example, the server system 112 may be configured to process the encoded bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded data 116 to generate reconstructed mesh data that can be rendered on a display or other type of rendering device. In some embodiments, one or more of the electronic devices 120 does not include a display component (e.g., is communicatively coupled to an external display device such as a head-mounted display and/or includes a media storage). In some embodiments, the electronic devices 120 are streaming clients. In some embodiments, the electronic devices 120 are configured to access the server system 112 to obtain the encoded data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a volumetric video conferencing device, a head-mounted display, and/or other type of electronic device.

In example operation of the communication system 100, the source device 102 transmits the encoded bitstream 108 to the server system 112. For example, the source device 102 may encode mesh data representing three-dimensional objects or scenes that are captured by the source device. The server system 112 receives the encoded bitstream 108 and may decode and/or encode the encoded bitstream 108 using the coder component 114. For example, the server system 112 may apply an encoding to the mesh data that is more optimal for network transmission and/or storage. The server system 112 may transmit the encoded data 116 (e.g., one or more coded bitstreams) to one or more of the electronic devices 120. Each electronic device 120 may decode the encoded data 116 and optionally render and display the decoded mesh data.

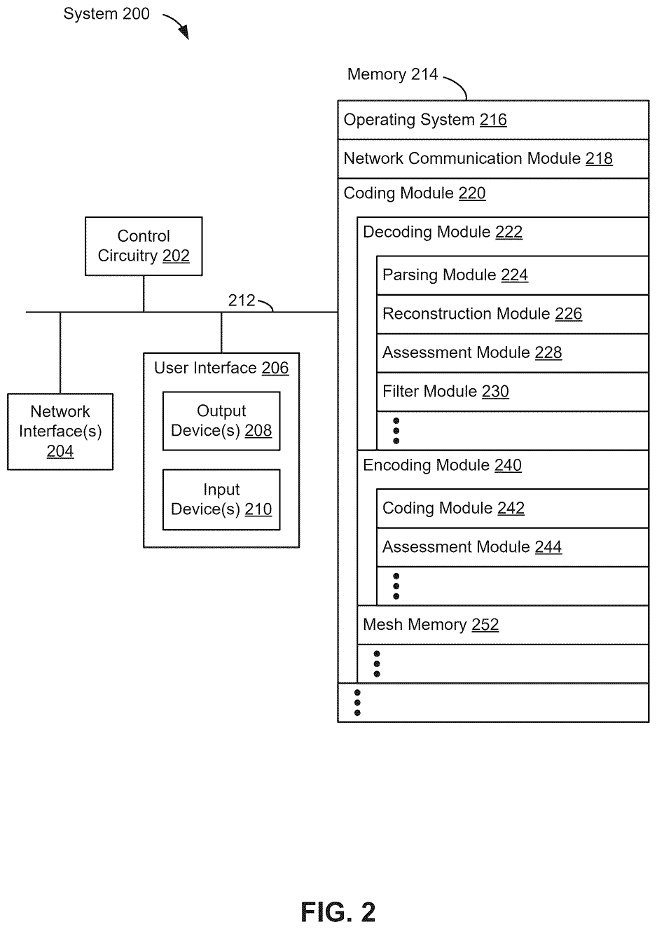

FIG. 2 is a block diagram illustrating a computing system 200 in accordance with some embodiments. The computing system 200 may be an instance of the server system 112, the source device 102, or one of the electronic devices 120. In some embodiments, the computing system 200 is configured to perform mesh quality assessment operations, including viewpoint selection for projection-based mesh quality metrics. The computing system 200 includes control circuitry 202, one or more network interfaces 204, a memory 214, a user interface 206, and one or more communication buses 212 for interconnecting these components. In some embodiments, the control circuitry 202 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 204 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 206 includes one or more output devices 208 and/or one or more input devices 210. The input device(s) 210 may include one or more of: a keyboard, a mouse, a trackpad, a touch screen, a data-glove, a joystick, a microphone, a scanner, a camera, or the like. The output device(s) 208 may include one or more of: an audio output device (e.g., a speaker), a visual output device (e.g., a display or monitor), or the like.

The memory 214 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 214 optionally includes one or more storage devices remotely located from the control circuitry 202. The memory 214, or, alternatively, the non-volatile solid-state memory device(s) within the memory 214, includes a non-transitory computer-readable storage medium. In some embodiments, the memory 214, or the non-transitory computer-readable storage medium of the memory 214, stores the following programs, modules, instructions, and data structures, or a subset or superset thereof:
an operating system 216 that includes procedures for handling various basic system services and for performing hardware-dependent tasks;
a network communication module 218 that is used for connecting the computing system 202 to other computing devices via the one or more network interfaces 204 (e.g., via wired and/or wireless connections);
a coding module 220 for performing various functions with respect to encoding and/or decoding data, such as three-dimensional mesh data. The coding module 220 including, but not limited to, one or more of:
   a decoding module 222 for performing various functions with respect to decoding encoded data, such as reconstructing mesh geometry, connectivity, and texture information; and
   an encoding module 240 for performing various functions with respect to encoding data, such as compressing vertex positions, face connectivity, and associated texture maps; and
a mesh memory 252 for storing mesh data, e.g., for use with the coding module 220. In some embodiments, the mesh memory 252 includes one or more of: a reference mesh memory for storing source meshes, a buffer memory for storing intermediate mesh data during processing, and a current mesh memory for storing reconstructed meshes.

In some embodiments, the decoding module 222 includes a parsing module 224 for parsing encoded bitstreams (e.g., mesh bitstreams), a reconstruction module 226 (e.g., configured to perform the various functions to reconstruct compressed/streamed meshes including vertex positions, face connectivity, and texture coordinates), an assessment module 228 (e.g., configured to perform the various functions to assess the quality of mesh reconstructions), and a filter module 230 (e.g., configured to perform the various functions related to filtering mesh data such as smoothing or denoising operations). In some embodiments, the assessment module 228 is configured to select viewpoints for evaluating reconstructed meshes, render the meshes from the selected viewpoints, and compute quality metrics based on the rendered views. The assessment module 228 may implement viewpoint selection techniques including random viewpoint selection, uniform angular spacing, exclusion ranges, multiple rotation axes, spherical coordinate systems, variable viewing distances, and Fibonacci sphere sampling.

In some embodiments, the encoding module 240 includes a coding module 242 (e.g., configured to perform the various functions to encode meshes such as geometry compression, connectivity encoding, and texture map compression) and an assessment module 244 (e.g., configured to perform the various functions to assess the quality of potential mesh encodings and subsequent reconstructions using projection-based quality metrics). In some embodiments, the decoding module 222 and/or the encoding module 240 include a subset of the modules shown in FIG. 2. For example, a shared assessment module may be used by both the decoding module 222 and the encoding module 240 to evaluate mesh quality, e.g., using viewpoint-based rendering and two-dimensional image quality metrics.

Each of the above identified modules stored in the memory 214 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the mesh coding module 220 optionally does not include separate decoding and encoding modules, but rather uses a same set of modules for performing both sets of functions. In some embodiments, the memory 214 stores a subset of the modules and data structures identified above. In some embodiments, the memory 214 stores additional modules and data structures not described above, such as rendering modules for generating two-dimensional projections of meshes from selected viewpoints, random number generators for viewpoint selection, and modules for computing two-dimensional image quality metrics.

Although FIG. 2 illustrates the computing system 200 in accordance with some embodiments, FIG. 2 is intended more as a functional description of the various features that may be present in one or more computing systems configured for mesh coding and quality assessment rather than a structural schematic of the embodiments described herein. In practice, items shown separately could be combined and some items could be separated. For example, some items shown separately in FIG. 2 could be implemented on single servers and single items could be implemented by one or more servers. The actual number of servers used to implement the computing system 200, and how features are allocated among them, will vary from one implementation to another and, optionally, depends in part on the complexity of the mesh data being processed, the number of viewpoints used for quality assessment, and the computational requirements of the rendering and quality metric calculations.

### Example Coding Techniques

The coding processes and techniques described below may be performed at the devices and systems described above (e.g., the source device 102, the server system 112, and/or the electronic device 120). According to some embodiments, a viewpoint selection process is used to evaluate meshes.

Mesh coding encompasses techniques for compressing and decompressing three-dimensional mesh data to reduce storage requirements and transmission bandwidth while preserving visual fidelity. A mesh encoder may receive input mesh data including vertex positions, face connectivity information, and associated texture maps, and may apply various compression techniques to generate a compressed bitstream. The compression process may involve quantization of vertex coordinates, predictive coding of connectivity information, and encoding of texture data using image or video compression techniques. A mesh decoder receives the compressed bitstream and performs inverse operations to reconstruct the mesh data. The reconstructed mesh may differ from the original source mesh due to lossy compression operations, transmission errors, or other processing steps in the coding pipeline. Mesh coding standards define syntax and semantics for representing compressed mesh data in bitstreams that can be decoded by conforming decoders.

Evaluating the quality of reconstructed meshes is important for assessing the performance of mesh coding systems and for guiding encoder decisions during rate-distortion optimization. Compression, transmission, and other processing operations may introduce distortions that degrade the visual quality of reconstructed meshes relative to their source counterparts. These distortions may manifest as geometric errors in vertex positions, artifacts in texture appearance, or discontinuities in surface smoothness. Projection-based mesh quality metrics provide an approach for quantifying such distortions by rendering the source mesh and the reconstructed mesh from multiple viewpoints and applying two-dimensional image quality metrics to the rendered views. The quality scores from individual viewpoints may be aggregated to produce a combined quality metric that correlates with subjective quality assessments. The selection of viewpoints for such projection-based assessments may influence the accuracy and reliability of the resulting quality measurements.

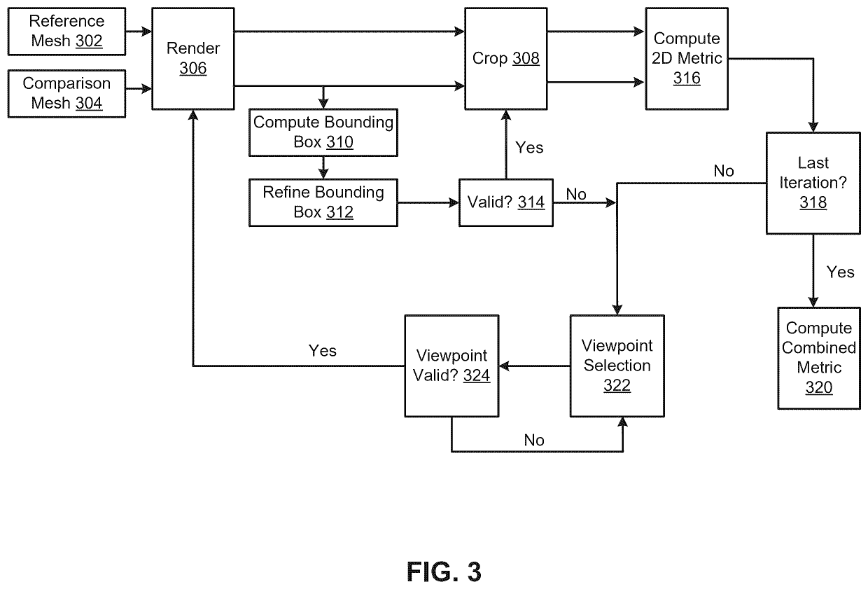

FIG. 3 illustrates a flowchart for a projection-based mesh quality metric process in accordance with some embodiments. In some embodiments, the process is performed by any of the devices and/or systems described previously. The process receives a reference mesh 302 and a comparison mesh 304 (e.g., a reconstructed mesh) as inputs. In some embodiments, the reference mesh 302 and the reconstructed mesh 304 are read from files in OBJ format. The process may apply to arbitrary polygon meshes for quality assessment. The assessment module (e.g., the assessment module 228 or 244) may perform the operations illustrated in FIG. 3 to evaluate the quality of the comparison mesh 304 relative to the reference mesh 302.

At step 306, both the reference mesh 302 and the reconstructed mesh 304 are rendered to generate viewpoint images. In some embodiments, the rendering is performed using the open3d library for generating viewpoint images. In some embodiments, (e.g., to optimize runtime), the mesh file is read once, and the mesh may be rotated to different viewpoints rather than re-reading the mesh file for each viewpoint.

With continued reference to FIG. 3, at step 310, a bounding box is computed. In some embodiments, the bounding box is computed on the comparison mesh 304 (e.g., the distorted mesh) and the bounding box size and location are inherited by the reference mesh 302. Computing the bounding box on the distorted mesh may prevent additional resizing or merging of bounding boxes while still allowing the two-dimensional metric to be applied to images of similar resolution. At step 312, the bounding box is refined. The bounding box may be cropped by a fixed amount, such as 64 pixels per edge, to reduce the percentage of empty pixels in the bounding box. The cropping step may result in the two-dimensional metric being computed on proportionally more valid pixels.

At step 314, a validity check is performed. A viewpoint may be disqualified if the resulting cropped bounding box has a width or height below a threshold, such as 200 pixels. When the bounding box does not meet this size criterion, the viewpoint may be assumed to correspond to a viewpoint that is not reliable for quality evaluation. If the viewpoint is valid (Yes branch from step 314), the process proceeds to step 308 for cropping. If the viewpoint is not valid (No branch from step 314), the process moves to step 322 to select a new viewpoint.

At step 308, the rendered images are cropped based on the computed and refined bounding box. In some embodiments, the crop of the rendered viewpoint and conversion to YUV format are combined in a single step to reduce file reading and writing operations. The process may include a debug mode where cropped viewpoint outputs are written as PNG files for visualization, which may be useful because the size of cropped viewpoints varies and may be unknown, preventing opening with usual visualization tools when only YUV files are written.

Following the cropping at step 308, the process proceeds to step 316, where a two-dimensional metric is computed for the rendered and cropped viewpoint images. In some embodiments, the assessment module uses VMAF as the two-dimensional metric for computing quality scores on rendered viewpoints. In some embodiments, the assessment module uses a peak signal-to-noise ratio (PSNR) as the two-dimensional metric for quality evaluation. In some embodiments, the assessment module uses a structural similarity index (SSIM) as the two-dimensional metric for quality evaluation. The assessment module may also use a mask approach for computing pixel-level metrics on the object without computing a bounding box.

In some embodiments, the quality metric score is on a scale of 1 to 5, e.g., where a score of 5 corresponds to excellent quality with imperceptible errors, a score of 4 corresponds to good quality with perceptible but not annoying errors, a score of 3 corresponds to fair quality with slightly annoying errors, a score of 2 corresponds to poor quality with annoying errors, and a score of 1 corresponds to bad quality with very annoying errors. The assessment module may compute a D1-PSNR metric, which measures geometry distortion based on point-to-point distance, D2-PSNR metric, which measures geometry distortion based on point-to-plane distance, and/or a lumaPSNR (also sometimes referred to as YUV-PSNR) metric, which considers both geometry and texture information.

After computing the two-dimensional metric at step 316, the process moves to step 318 to determine if this is the last iteration. The process may include a convergence threshold parameter that stops adding new viewpoints when the change in score falls below the threshold. In some embodiments, the convergence threshold is set to 1.0 on the VMAF scale for determining when to stop adding viewpoints. In some embodiments, the convergence threshold is set to 0.5 on the VMAF scale. A visual difference may be noticed for a VMAF score difference of 5 (corresponding to 1 JND, or just noticeable difference), so a threshold of 1.0 or 0.5 may be more conservative.

The process may define a minimum number of viewpoints (Tmin) that are considered before convergence can be claimed. In some embodiments, the minimum number of viewpoints is 3. In some embodiments, the minimum number of viewpoints is 8. The minimum viewpoint count may serve as a safeguard to ensure that convergence is not achieved by chance too early. The process may also define a maximum number of viewpoints (Tmax) to prevent endless computation. In some embodiments, the maximum number of viewpoints is 10. In some embodiments, the maximum number of viewpoints is 16. For example, when the change in score obtained when adding a new viewpoint falls below the convergence threshold, and the count of qualified viewpoints falls within the range defined by Tmin and Tmax, the iteration process stops and no additional viewpoints are incorporated.

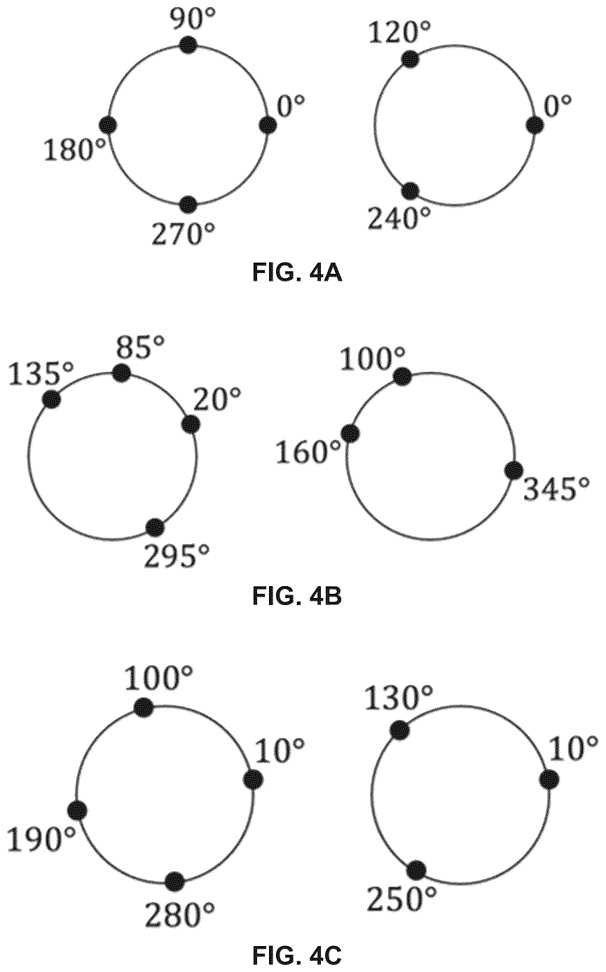

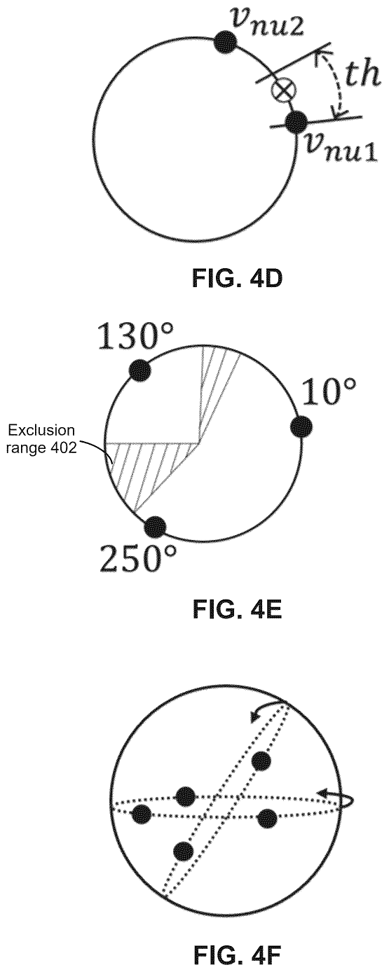

If at step 318, the system determines that this is not the last iteration (No branch), the process proceeds to step 322 for viewpoint selection. At step 322, viewpoint selection occurs to determine the next viewpoint for evaluation. The viewpoint selection process is described in more detail below with reference to FIGS. 4A-4H. The process then moves to step 324, where a viewpoint validity check is performed. If the viewpoint is valid (Yes branch from step 324), the process returns to step 306 to render the meshes from the new viewpoint. If the viewpoint is not valid (No branch from step 324), the process returns to step 322 to select a different viewpoint. The viewpoint selection techniques described herein, including random viewpoint selection, uniform angular spacing, exclusion ranges, multiple rotation axes, spherical coordinate systems, variable viewing distances, and Fibonacci sphere sampling, may be applied at step 322.

If step 318 determines that this is the last iteration (Yes branch), the process moves to step 320, where a combined metric is computed from the individual viewpoint metrics. In some embodiments, the combined quality metric is computed as the median of the quality scores from all qualified viewpoints. Using the median may allow the process to reject possible extreme outliers from the final quality score.

The quality of the projection-based mesh quality metric may be evaluated using various statistical indicators. In some embodiments, a Pearson Linear Correlation Coefficient (PLCC) is used to evaluate the prediction accuracy of the quality metric. In some embodiments, a Spearman Rank Order Correlation Coefficient (SROCC) is used to evaluate the monotonicity of the quality metric. In some embodiments, a Root Mean Square Error (RMSE) is used to evaluate the prediction accuracy of the quality metric. In some embodiments, a Kendall Rank Order Correlation Coefficient (KROCC) is used to evaluate the monotonicity of the quality metric. A PLCC above 0.85 may indicate very strong correlation and a very good metric that is acceptable for decision taking. A PLCC above 0.80 may indicate strong correlation and a good metric that is acceptable for decision taking but may be confirmed with subjective tests or another metric. A PLCC between 0.60 and 0.80 may indicate moderate correlation that may not be considered for decision taking. A PLCC below 0.60 may indicate weak correlation that indicates a trend.

FIGS. 4A-4C illustrate various methods of viewpoint selection along a rotation axis in accordance with some embodiments. Referring to FIG. 4A, the diagrams illustrate uniform viewpoint selection starting from an initial viewpoint at 0 degrees. The left circular diagram in FIG. 4A depicts four viewpoints positioned at uniform angular intervals of 90 degrees around a rotation axis. The four viewpoints are located at 0 degrees, 90 degrees, 180 degrees, and 270 degrees around the circle. Each viewpoint is represented by a filled circle positioned on the circumference of the circular diagram, with the angular position of each viewpoint indicated by a degree label adjacent to the filled circle. The right circular diagram in FIG. 4A depicts three viewpoints positioned at uniform angular intervals of 120 degrees around the rotation axis. The three viewpoints are located at 0 degrees, 120 degrees, and 240 degrees around the circle.

In some embodiments, the number of uniformly selected viewpoints determines the angular spacing between viewpoints. When four viewpoints are selected, the angular spacing is 360 degrees divided by 4, which equals 90 degrees. When three viewpoints are selected, the angular spacing is 360 degrees divided by 3, which equals 120 degrees. The uniform angular spacing can provide coverage of the mesh from multiple directions around the rotation axis.

In some embodiments, the selection process includes pre-selecting some viewpoints at fixed angles while adding additional randomly selected viewpoints. For example, three viewpoints may be pre-selected at fixed angles such as 0 degrees, 135 degrees, and 270 degrees, and additional viewpoints may be randomly selected to supplement the pre-selected viewpoints. This hybrid fixed-random selection approach may provide a balance between consistent coverage from the pre-selected viewpoints and unpredictability from the randomly selected viewpoints. Pre-selecting all viewpoints at fixed angles may introduce bias, as a mesh codec could take into account knowledge of the viewpoint positions and optimize specifically for those known positions. Introducing randomly selected viewpoints may serve as a safeguard against such optimization.

With continued reference to FIGS. 4A-4C, each viewpoint (whether pre-selected or randomly selected) may be qualified based on whether the viewpoint is sufficiently distant from previously computed viewpoints. A viewpoint that is too close to an existing viewpoint may not provide additional information for quality assessment and may be disqualified. The qualification process may help ensure that the selected viewpoints provide diverse coverage of the mesh surface rather than clustering in a particular angular region.

FIGS. 4D-4F illustrate various viewpoint selection techniques in accordance with some embodiments. Referring to FIG. 4D, the diagram illustrates a viewpoint selection approach where viewpoints are required to be separated from one another by at least a threshold distance. The threshold distance may be an angular separation measured in degrees around a rotation axis. By enforcing a minimum separation between viewpoints, the assessment module may ensure that selected viewpoints provide diverse coverage of the mesh surface rather than clustering in a particular angular region. In some embodiments, the threshold distance is randomly selected from a predefined range to prevent mesh codecs from predicting the exact viewpoint positions.

Referring to FIG. 4E, the diagram depicts a circular representation of possible viewpoint angles around a mesh, with three viewpoints positioned at 10 degrees, 130 degrees, and 250 degrees indicated by filled circles along the circumference. An exclusion range 402 is shown as a hatched region extending from approximately the center of the circle toward the left side. The exclusion range 402 represents a range of viewing angles that are excluded from viewpoint selection during mesh quality evaluation. In some embodiments, the exclusion range 402 defines a subset of viewing angles that are not considered when selecting viewpoints for mesh quality evaluation. The exclusion range 402 may correspond to viewing angles that are less relevant for quality assessment, such as angles that view uniform or blank surfaces of a mesh. For example, a mesh representing a castle may have a floor surface that is relatively uniform in texture and geometry, and viewpoints facing the floor may provide less useful information for quality assessment compared to viewpoints facing more detailed surfaces such as walls or architectural features. By defining the exclusion range 402 to encompass viewing angles that face such uniform surfaces, the assessment module may focus quality evaluation on more relevant viewing angles.

With continued reference to FIG. 4E, the exclusion range 402 may be defined based on the type of mesh being evaluated. In some embodiments, for scanned meshes of humans, viewpoints facing the front of the human figure may be weighted more heavily than viewpoints facing the back. The front of a human figure may contain more detailed features such as facial characteristics, clothing details, and hand positions that are more perceptually relevant for quality assessment. The back of a human figure may contain less detailed surfaces that contribute less to the overall perceived quality of the mesh reconstruction. By defining the exclusion range 402 to exclude or reduce the weight of viewpoints facing the back of the human figure, the assessment module may produce quality scores that better correlate with subjective quality assessments. In some embodiments, a list of viewpoint ranges to be excluded is defined for a mesh, and the uniformly and non-uniformly selected viewpoints are constrained to not belong to the viewpoints in the excluded viewpoint lists. The exclusion range 402 may be specified as one or more angular ranges, such as a range from 180 degrees to 270 degrees, that define the excluded viewing angles. When the assessment module selects viewpoints for quality evaluation, the assessment module may check whether each candidate viewpoint falls within the exclusion range 402 and may reject candidate viewpoints that fall within the exclusion range 402.

Referring to FIG. 4F, the diagram illustrates viewpoint selection along multiple axes in accordance with some embodiments. Rather than limiting viewpoints to a single horizontal rotation axis, the assessment module may select viewpoints along multiple rotation axes to provide more comprehensive coverage of the mesh surface. In some embodiments, the number of axes is randomly selected using a random number generator. The multiple axes may be oriented at different angles relative to the mesh, such as a horizontal axis, a vertical axis, and one or more diagonal axes. By selecting viewpoints along multiple axes, the assessment module may capture quality variations across different regions of the mesh that may not be visible from viewpoints along a single axis. For example, a mesh representing a complex object may have detailed features on both horizontal and vertical surfaces, and viewpoints along multiple axes may be needed to adequately evaluate the quality of all surfaces.

The viewpoint selection techniques illustrated in FIGS. 4D-4F may be combined with one another and with other viewpoint selection techniques described herein. For example, the assessment module may use random viewpoint selection to select candidate viewpoints, enforce a minimum threshold distance between viewpoints as illustrated in FIG. 4D, filter out candidate viewpoints that fall within the exclusion range 402 as illustrated in FIG. 4E, and select viewpoints along multiple axes as illustrated in FIG. 4F. The assessment module may also use uniform angular spacing to select viewpoints while constraining the viewpoints to fall outside the exclusion range 402. The combination of these techniques may provide both unpredictability in viewpoint positions and focus on relevant viewing angles for quality assessment.

In some embodiments, the assessment module selects viewpoints using a spherical coordinate system. A spherical coordinate system defines the position of a point on a sphere using three parameters: a radial distance r from an origin at the center of the sphere, a polar angle θ measured from a reference axis (such as the positive z-axis) to a line connecting the origin to the point, and an azimuthal angle φ measured in a reference plane (such as the x-y plane) from a reference direction (such as the positive x-axis). The spherical coordinate system may consist of longitude in a range from 0 degrees to 360 degrees (0°≤θ≤360°) and latitude in a range from 0 degrees to 180 degrees (0°≤φ≤180°). The viewpoints may be selected by determining the angle on θ and φ respectively using the viewpoint selection procedures described herein, including random viewpoint selection, uniform angular spacing, and exclusion ranges. The spherical coordinate system may provide more comprehensive coverage of the mesh surface compared to viewpoint selection along a single rotation axis, as viewpoints may be positioned at any location on a viewing sphere surrounding the mesh.

In some embodiments, the viewing distance between a viewpoint and the mesh center may be varied. The radial distance r in the spherical coordinate system may be randomly selected for each viewpoint v as rv∈[rmin, rmax], where rmin is a minimum distance between the viewpoint and the mesh center and rmax is a maximum distance between the viewpoint and the mesh center. The minimum and maximum distances may be defined by the assessment module. Varying the viewing distance may enable closer inspection of intricate features when the viewpoint is positioned closer to the mesh (similar to a zoom-in operation) and broader views of the overall mesh when the viewpoint is positioned farther from the mesh (similar to a zoom-out operation). The variable viewing distance may be combined with the viewpoint selection procedures described herein.

In some embodiments, the assessment module uses Fibonacci sphere sampling (also sometimes referred to as golden angle spiral uniform sampling) to select viewpoints uniformly on a sphere. Fibonacci sphere sampling distributes points across a spherical surface such that the points are uniformly distributed, providing even coverage of the viewing sphere for mesh quality assessment. The golden angle for Fibonacci sphere sampling may be defined as g=½(1+sqrt(5)). For a given number of sampling viewpoints N and indices of the points where indices ∈[0, N−1], the latitude φ may be computed as φ=arccos(1−2*indices/N) and the longitude θ may be computed as θ=2π*g*indices. The Fibonacci sphere sampling technique may achieve uniform distribution of viewpoints across the viewing sphere, which may provide high coverage of the mesh surface for quality assessment. The Fibonacci sphere sampling technique may be combined with the other viewpoint selection procedures described herein.

In some embodiments, the assessment module enables rotation around both horizontal and vertical axes simultaneously for viewpoint selection. Rather than limiting viewpoints to rotation around a single axis (such as a vertical axis), the assessment module may rotate the mesh around both horizontal and vertical axes to generate viewpoints at various positions on the viewing sphere. Dual-axis rotation may capture quality variations across different regions of the mesh that may not be visible from viewpoints generated by rotation around a single axis.

In some embodiments, for interior mesh objects such as rooms, the initial viewpoint may be positioned within the object with subsequent viewpoints achieved through rotations around this internal viewpoint. By default, viewpoints may be calculated by rotating around a vertical axis starting from an initial viewpoint positioned outside the object. This default approach may be well-suited for meshes representing objects that are viewed from the exterior, such as meshes of people, animals, or standalone objects. However, for meshes representing interior spaces such as rooms, the quality may differ based on whether the viewpoint is taken inside or outside the object. For such meshes, positioning the initial viewpoint within the object and generating subsequent viewpoints through rotations around this internal viewpoint may provide more relevant quality assessment. The assessment module may modify the rendering process so that the initial viewpoint is positioned within the object for interior mesh types.

In some embodiments, the assessment module defines intrinsic and extrinsic camera parameters to establish the initial viewpoint position for specific mesh types. The initial viewpoint may represent a combined translation and rotation that is established by defining both intrinsic parameters (such as focal length and principal point) and extrinsic parameters (such as camera position and orientation) of the respective cameras. The intrinsic and extrinsic parameters may be specified for particular meshes, such as room meshes where interior viewpoints are more relevant for quality evaluation. By defining camera parameters for specific mesh types, the assessment module may provide manual guidance to indicate which viewpoints are more relevant for quality evaluation, similar to how subjective tests may be performed with specific viewing conditions.

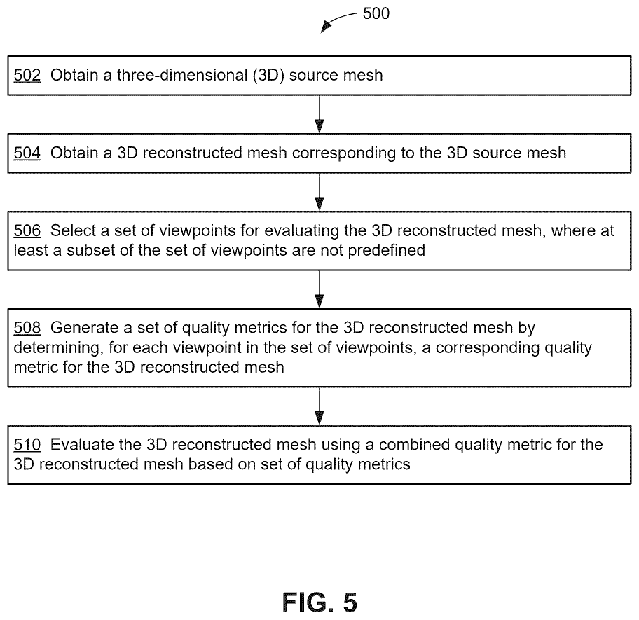

FIG. 5 is a flow diagram illustrating a method 500 of mesh assessment in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 214) of the computing system.

The computing system receives (502) obtains a three-dimensional (3D) source mesh. In some embodiments, the 3D source mesh is read from a file in OBJ format. In some embodiments, the 3D source mesh is an arbitrary polygon mesh. In some embodiments, the 3D source mesh represents a human body, an interior room scene, or an exterior object scan. In some embodiments, the 3D source mesh includes geometric information such as vertex positions and connectivity, as well as associated texture and attribute data.

The computing system obtains (504) a 3D reconstructed mesh corresponding to the 3D source mesh. In some embodiments, the 3D reconstructed mesh is generated by decoding an encoded bitstream that was produced by a mesh encoder, such as an encoder conforming to V-DMC or VVM standards. In some embodiments, the 3D reconstructed mesh includes distortions introduced by compression, transmission, or other processing operations. In some embodiments, the 3D reconstructed mesh is read from a file in OBJ format.

The computing system selects (506) a set of viewpoints for evaluating the 3D reconstructed mesh, where at least a subset of the set of viewpoints are not predefined. In some embodiments, selecting the set of viewpoints includes identifying a number of viewpoints using a random number generator. For example, the number of viewpoints may be randomly selected from a range defined by a minimum number of viewpoints and a maximum number of viewpoints. In some embodiments, the viewpoints are assigned uniform angular spacing based on the number of viewpoints. In some embodiments, the viewpoints are assigned random angular positions along a rotation axis. In some embodiments, a first viewpoint is randomly selected using a random number generator, and the remaining viewpoints are uniformly distributed from that starting position. In some embodiments, selecting the set of viewpoints includes requiring that viewpoints are separated from one another by at least a threshold amount, where the threshold amount may be randomly selected from a predefined range. In some embodiments, selecting the set of viewpoints includes obtaining one or more exclusion ranges and requiring that viewpoints in the set of viewpoints are not positioned within the one or more exclusion ranges. In some embodiments, selecting the set of viewpoints includes selecting one or more axes for the set of viewpoints and assigning viewpoints from along the one or more axes. In some embodiments, the number of axes is randomly selected using a random number generator. In some embodiments, the set of viewpoints are selected using a spherical coordinate system. In some embodiments, selecting the set of viewpoints includes selecting one or more viewing distances for the set of viewpoints, where the viewing distance between a viewpoint and the mesh center may be randomly selected within a range defined by a minimum distance and a maximum distance. In some embodiments, selecting the set of viewpoints includes using a Fibonacci sphere sampling algorithm to select viewpoints uniformly distributed across a viewing sphere.

The computing system generates (508) a set of quality metrics for the 3D reconstructed mesh by determining, for each viewpoint in the set of viewpoints, a corresponding quality metric for the 3D reconstructed mesh. In some embodiments, generating the set of quality metrics includes rendering the 3D source mesh and the 3D reconstructed mesh from each viewpoint to generate viewpoint images. In some embodiments, the corresponding quality metric for each viewpoint is computed using a two-dimensional image quality metric applied to the rendered viewpoint images.

In some embodiments, the computing system evaluates (510) the 3D reconstructed mesh using a combined quality metric for the 3D reconstructed mesh based on set of quality metrics. In this way, a reconstructed mesh may be evaluated using randomly selected viewpoints. In some embodiments, the combined quality metric is computed as a median of the quality metrics from the set of quality metrics. In some embodiments, the combined quality metric is computed as an average of the quality metrics from the set of quality metrics. In some embodiments, the process iteratively adds viewpoints until a convergence threshold is reached. In some embodiments, the system enforces a minimum number of viewpoints and a maximum number of viewpoints regardless of convergence.

In some embodiments, the system randomly selects a number of uniform viewpoints. A uniform random number generator may be used to draw a positive integer between a lower bound and an upper bound. Then, viewpoints may be uniformly selected along the same rotation axis (e.g., as illustrated in FIG. 4A).

In some embodiments, the system randomly selects a number of non-uniform viewpoints. A uniform random number generator may be used to draw a positive integer between a lower bound and an upper bound. Then, viewpoints may be randomly selected along the same rotation axis (e.g., as illustrated in FIG. 4B).

In some embodiments, the system selects the first viewpoint in a set of uniformly selected viewpoints at random. A uniform random number generator may be used to select the first viewpoint. Then, the rest of the viewpoints may be uniformly selected starting from the first viewpoint (e.g., as illustrated in FIG. 4C).

In some embodiments, the system randomly selects an angular threshold below which a new non-uniform viewpoint shall not be selected. A maximum angular threshold may be defined by the software to allow for sufficient viewpoints to be selected. Then, a uniform random number generator may be used to select an angular threshold that is less than or equal to the maximum angular threshold (e.g., as illustrated in FIG. 4D).

In some embodiments, the system uses only a subset of all possible viewing angles in the viewpoint selection process. Some viewpoints may be less relevant, and it is beneficial to exclude them in the quality evaluation metric. For instance, for scanned meshes of humans, viewpoints facing the front would be more relevant than the ones facing the back. A list of viewpoint ranges to be excluded may be defined for a mesh and the uniformly and non-uniformly selected viewpoints shall not belong to the viewpoints in the excluded viewpoints lists (e.g., as illustrated in FIG. 4E).

In some embodiments, the system randomly samples an axis of rotation (e.g., in addition to, or alternatively to, the horizontal axis). In some embodiments, the system randomly determines the number of axes from which to sample viewpoints. For example, a uniform random number generator may be used to sample the number of axes nₐₓₑₛ∈[1,nₐₓₑₛ₍ₘₐₓ₎], where nₐₓₑₛ₍ₘₐₓ₎ is the maximum possible number of axes defined by the software. Then, a random axis is sampled nₐₓₑₛ times without replacement. Finally, for each sampled axis, the viewpoints are selected following any of the procedures described herein. FIG. 4F illustrates an example of selecting viewpoints along multiple axes.

In some embodiments, the system uses a spherical coordinate system to select viewpoint on a sphere. The viewpoints may be selected by determining the angle on θ and φ respectively with any of the procedures described herein.

In some embodiments, the viewing distance between the viewpoint and the displayed mesh center is selected randomly. For example, the radius r in a spherical coordinate system can be randomly selected for each viewpoint v as rᵥ∈[rₘᵢₙ, rₘₐₓ], where rₘᵢₙ and rₘₐₓ is respectively the minimum and maximum possible distance between viewpoint and the mesh center defined by the software.

In some embodiments, golden angle spiral unform sampling is used to select viewpoints uniformly on a sphere.

Although FIG. 5 illustrates a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 500) of selecting viewpoints. The method includes (i) obtaining a 3D source mesh; (ii) obtaining a 3D reconstructed mesh corresponding to the 3D source mesh (or other mesh for comparison with the source mesh); (iii) selecting a set of viewpoints for evaluating the 3D reconstructed mesh, where at least a subset of the set of viewpoints are not predefined; (iv) generating a set of quality metrics for the 3D reconstructed mesh by determining, for each viewpoint in the set of viewpoints, a corresponding quality metric for the 3D reconstructed mesh; and (v) evaluating the 3D reconstructed mesh using a combined quality metric for the 3D reconstructed mesh based on set of quality metrics. In this way, a reconstructed mesh may be evaluated using randomly selected viewpoints.

(A2) In some embodiments of A1, selecting the set of viewpoints for evaluating the 3D reconstructed mesh comprises identifying a number of viewpoints for the set of viewpoints using a random number generator. For example, the number of uniform viewpoints may be randomly selected. A random number generator may be used to draw a positive integer up to a maximum possible number of uniformly selected viewpoints defined by the software.

(A3) In some embodiments of A2, selecting the set of viewpoints for evaluating the 3D reconstructed mesh comprises assigning uniform angles for the set of viewpoints based on the number of viewpoints. For example, viewpoints are uniformly selected along the same rotation axis. In one example, the number of viewpoints is equal to 4, then the uniform viewpoints are set as 0°, 90°, 180°, and 270°. An example of this process is shown in FIG. 4A.

(A4) In some embodiments of A2, selecting the set of viewpoints for evaluating the 3D reconstructed mesh comprises assigning random angles for the set of viewpoints. For example, viewpoints are randomly selected along the same rotation axis without replacement (e.g., two uniformly and/or non-uniformly selected viewpoints cannot be the same). In one example, the number of viewpoints is equal to 5, and the non-uniform viewpoints are set as 220°, 45°, 158°, 341°, and 202°. An example of this process is shown in FIG. 4B.

(A5) In some embodiments of any of A1-A4, selecting the set of viewpoints for evaluating the 3D reconstructed mesh comprises: (i) using a random number generator to select a first viewpoint for the set of viewpoints; and (ii) selecting a remainder of the set of viewpoints using the first viewpoint and a uniform distance between viewpoints. For example, a first viewpoint in a set of uniformly selected viewpoints is selected at random. A uniform random number generator may be used to select the first viewpoint (e.g., select an angle for the first viewpoint). Then, the rest of the viewpoints may be uniformly selected starting from the first viewpoint. In one example, the first viewpoint is set as 34° and the number of viewpoints is equal to 4. Then, the uniform viewpoints are assigned as 34°, 124°, 214°, and 304°. An example of this process is shown in FIG. 4C.

(A6) In some embodiments of any of A1-A5, selecting the set of viewpoints for evaluating the 3D reconstructed mesh comprises requiring that viewpoints are separated from one another by at least a threshold amount. For example, a max angular threshold may be defined by the software to allow for sufficient viewpoints to be selected. Then, a uniform random number generator may be used to select an angular threshold. In one example, the threshold is 30° and the first non-uniform viewpoint is 276°. Then, the second non-uniform viewpoint is required to be selected from the range [246°, 306°]. Similarly, the third viewpoint is required not be within the angular threshold of the first threshold or the second threshold. An example of excluding viewpoints within an angular threshold is shown in FIG. 4D.

(A7) In some embodiments of A6, the threshold amount is randomly selected from a predefined range. For example, an angular threshold is randomly selected below which a new non-uniform viewpoint shall not be selected.

(A8) In some embodiments of any of A1-A7, selecting the set of viewpoints for evaluating the 3D reconstructed mesh comprises: (i) obtaining one or more exclusion ranges; and (ii) requiring that viewpoints in the set of viewpoints are not positioned within the one or more exclusion ranges. For example, only a subset of all possible viewing angles is used in the viewpoint selection process. A list of viewpoint ranges to be excluded may be defined for a mesh and the uniformly and non-uniformly selected viewpoints shall not belong to the viewpoints in the excluded viewpoints lists. An example of excluded viewpoints ranges is shown in FIG. 4E.

(A9) In some embodiments of any of A1-A8, selecting the set of viewpoints for evaluating the 3D reconstructed mesh comprises: (i) selecting one or more axes for the set of viewpoints; and (ii) assigning viewpoints of the set of viewpoints from along the one or more axes. In some systems, viewpoints are sampled only along the horizontal axis. While rotations about the horizontal axis may be a natural choice for viewpoint and mimics human observers, viewpoints selected along other arbitrary axes may capture certain artifacts better and help generalize the metric. For example, an axis of rotation may be randomly sampled (e.g., in addition to the horizontal axis).

(A10) In some embodiments of A9, selecting the one or more axes for the set of viewpoints comprises identifying a number of axes for the set of viewpoints using a random number generator. For example, the number of axes to sample viewpoints from may be randomly determined. As an example, a uniform random number generator may be used to sample the number of axes up to a maximum possible number of axes defined by the software. An example of sampling viewpoints along multiple axes is shown in FIG. 4F.

(A11) In some embodiments of any of A1-A10, the set of viewpoints are selected using a spherical coordinate system.

(A12) In some embodiments of any of A1-A11, selecting the set of viewpoints for evaluating the 3D reconstructed mesh comprises selecting one or more viewing distances for the set of viewpoints. For example, the viewing distance between the viewpoint and the displayed mesh center can be random. As an example, the radius in the spherical coordinate system can be selected (e.g., randomly selected) for each viewport from a range between a minimum and maximum distance between viewpoint and the mesh center defined by the software.

(A13) In some embodiments of any of A1-A12, selecting the set of viewpoints for evaluating the 3D reconstructed mesh comprises using a Fibonacci sphere sampling algorithm to select the set of viewpoints.

In another aspect, some embodiments include a computing system (e.g., the server system 112) including control circuitry (e.g., the control circuitry 202) and memory (e.g., the memory 214) coupled to the control circuitry, the memory storing one or more sets of instructions configured to be executed by the control circuitry, the one or more sets of instructions including instructions for performing any of the methods described herein (e.g., the method 500 and A1-A13).

In yet another aspect, some embodiments include a non-transitory computer-readable storage medium storing one or more sets of instructions for execution by control circuitry of a computing system, the one or more sets of instructions including instructions for performing any of the methods described herein (e.g., the method 500 and A1-A13). In some embodiments, a memory or non-transitory computer-readable storage medium stores a bitstream including any of the features (e.g., syntax and encoded information) disclosed herein.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of selecting viewpoints, the method comprising:
obtaining a three-dimensional (3D) source mesh;
obtaining a 3D reconstructed mesh corresponding to the 3D source mesh;
selecting a set of viewpoints for evaluating the 3D reconstructed mesh, wherein at least a subset of the set of viewpoints are not predefined;
generating a set of quality metrics for the 3D reconstructed mesh by determining, for each viewpoint in the set of viewpoints, a corresponding quality metric for the 3D reconstructed mesh; and
evaluating the 3D reconstructed mesh using a combined quality metric for the 3D reconstructed mesh based on set of quality metrics.

2. The method of claim 1, wherein selecting the set of viewpoints for evaluating the 3D reconstructed mesh comprises identifying a number of viewpoints for the set of viewpoints using a random number generator.

3. The method of claim 2, wherein selecting the set of viewpoints for evaluating the 3D reconstructed mesh comprises assigning uniform angles for the set of viewpoints based on the number of viewpoints.

4. The method of claim 2, wherein selecting the set of viewpoints for evaluating the 3D reconstructed mesh comprises assigning random angles for the set of viewpoints.

5. The method of claim 1, wherein selecting the set of viewpoints for evaluating the 3D reconstructed mesh comprises:
using a random number generator to select a first viewpoint for the set of viewpoints; and
selecting a remainder of the set of viewpoints using the first viewpoint and a uniform distance between viewpoints.

6. The method of claim 1, wherein selecting the set of viewpoints for evaluating the 3D reconstructed mesh comprises requiring that viewpoints are separated from one another by at least a threshold amount.

7. The method of claim 6, wherein the threshold amount is randomly selected from a predefined range.

8. The method of claim 1, wherein selecting the set of viewpoints for evaluating the 3D reconstructed mesh comprises:
obtaining one or more exclusion ranges; and
requiring that viewpoints in the set of viewpoints are not positioned within the one or more exclusion ranges.

9. The method of claim 1, wherein selecting the set of viewpoints for evaluating the 3D reconstructed mesh comprises:
selecting one or more axes for the set of viewpoints; and
assigning viewpoints of the set of viewpoints from along the one or more axes.

10. The method of claim 9, wherein selecting the one or more axes for the set of viewpoints comprises identifying a number of axes for the set of viewpoints using a random number generator.

11. The method of claim 1, wherein the set of viewpoints are selected using a spherical coordinate system.

12. The method of claim 1, wherein selecting the set of viewpoints for evaluating the 3D reconstructed mesh comprises selecting one or more viewing distances for the set of viewpoints.

13. The method of claim 1, wherein selecting the set of viewpoints for evaluating the 3D reconstructed mesh comprises using a Fibonacci sphere sampling algorithm to select the set of viewpoints.

14. A computing system, comprising:
control circuitry; and
memory storing one or more programs configured to be executed by the control circuitry, the one or more programs further comprising instructions for:
obtaining a three-dimensional (3D) source mesh;
obtaining a 3D reconstructed mesh corresponding to the 3D source mesh;
selecting a set of viewpoints for evaluating the 3D reconstructed mesh, wherein at least a subset of the set of viewpoints are not predefined;
generating a set of quality metrics for the 3D reconstructed mesh by determining, for each viewpoint in the set of viewpoints, a corresponding quality metric for the 3D reconstructed mesh; and
evaluating the 3D reconstructed mesh using a combined quality metric for the 3D reconstructed mesh based on set of quality metrics.

15. The computing system of claim 14, wherein selecting the set of viewpoints for evaluating the 3D reconstructed mesh comprises identifying a number of viewpoints for the set of viewpoints using a random number generator.

16. The computing system of claim 14, wherein selecting the set of viewpoints for evaluating the 3D reconstructed mesh comprises requiring that viewpoints are separated from one another by at least a threshold amount.

17. The computing system of claim 14, wherein selecting the set of viewpoints for evaluating the 3D reconstructed mesh comprises selecting one or more viewing distances for the set of viewpoints.

18. A non-transitory computer-readable storage medium storing one or more programs for execution by control circuitry of a computing system, the one or more programs comprising instructions for:
obtaining a three-dimensional (3D) source mesh;
obtaining a 3D reconstructed mesh corresponding to the 3D source mesh;
selecting a set of viewpoints for evaluating the 3D reconstructed mesh, wherein at least a subset of the set of viewpoints are not predefined;
generating a set of quality metrics for the 3D reconstructed mesh by determining, for each viewpoint in the set of viewpoints, a corresponding quality metric for the 3D reconstructed mesh; and
evaluating the 3D reconstructed mesh using a combined quality metric for the 3D reconstructed mesh based on set of quality metrics.

19. The non-transitory computer-readable storage medium of claim 18, wherein selecting the set of viewpoints for evaluating the 3D reconstructed mesh comprises identifying a number of viewpoints for the set of viewpoints using a random number generator.

20. The non-transitory computer-readable storage medium of claim 18, wherein selecting the set of viewpoints for evaluating the 3D reconstructed mesh comprises requiring that viewpoints are separated from one another by at least a threshold amount.
